(19) United States
(12) Patent Application Publication
(10) Pub. No.: US 2010/0231139 A1
(43) Pub. Date: Sep. 16, 2010

(54) DRIVING CIRCUIT FOR INSTANT LIGHT EMITTING DIODE SHUTDOWN

(76) Inventor: Steef van BECKHOVEN, Eindhoven (NL)

Correspondence Address: Muncy, Geissler, Olds & Lowe, PLLC, 4000 Legato Road, Suite 310, FAIRFAX, VA, 22033, US

(21) Appl. No.: 12/470,860

(22) Filed: May 22, 2009

(30) Foreign Application Priority Data
Mar. 13, 2009 (CN) 200910118481.5

(51) Int. Cl. H05B 37/02

(52) U.S. Cl. 315/294

(57) ABSTRACT

A driving circuit for instant LED shutdown includes: a light emission driving circuit having a first PWM unit and a power converting unit, the power converting unit generating a driving current signal according to a signal generated by the first PWM unit, so as to drive the LED; a shunt parallel-connected with the LED for shunting a residual driving current after the power converting unit is turned off; and a second PWM unit for generating a signal which level is opposite to that of the signal from the first PWM unit so as to switch on or off an electrical connection between the shunt and the light emission driving circuit. When the signal from the second PWM unit is at a high level, the electrical connection is switched on so that a majority of the residual driving current flows to the shunt, thereby achieving instant LED shutdown.

### BACKGROUND OF THE INVENTION

1. Technical Field

The present invention relates to driving circuits for light-emitting diodes (LEDs). More particularly, the present invention relates to a driving circuit that achieves instant LED shutdown so as to eliminate delayed LED shutdown.

2. Description of Related Art

The so-called Pulse Width Modulation (hereinafter abbreviated as PWM) refers to a technique for converting analog signals into pulse signals. It primarily serves to monitor the output conditions of a power circuit and to provide signals for controlling electronic components. FIG. 1 shows a current signal converted into a pulse signal with a pulse width of tA in an ideal condition. The waveform of a PWM signal has a leading edge W1 and a trailing edge W2. The leading edge W1 reflects a toggle mode where the PWM signal rises to a high level from a low level, and the trailing edge W2 reflects another toggle mode where the PWM signal descends to the low level from the high level. The time consumed for completing the leading edge W1 is referred to as the rising time t1, and the time consumed for completing the trailing edge W2 is referred to as the falling time t2. The shorter the rising time t1 and the falling time t2 are, the steeper the leading edge W1 and the trailing edge W2 of the signal will be.

Referring to FIG. 2, as for a control circuit of an LED, the falling time t2 related to the trailing edge W2 of a PWM signal indicates the time the LED takes to go off completely. In other words, the closer the waveform of the PWM signal is to the ideal waveform of FIG. 1, the closer the falling time is to 0, meaning that the LED can be shut down immediately without any time delay. However, referring again to the practical PWM waveform shown in FIG. 2, the trailing edge W2 of the PWM signal diverges from the ideal waveform of FIG. 1 so as to lead to undesirable delayed shutdown of the LED. For instance, assuming the falling time t2 related to the trailing edge W2 of the PWM signal is 500 ms, it takes 500 ms for the LED to go out completely. Such delayed shutdown is unfavorable especially in an application where the LED is configured to blink in such a way that only when the time interval i between two blinks is greater than 500 ms can a meaningful blinking effect be recognized by naked human eyes. Therefore, for a billboard composed of LEDs and configured to present animations or text scrolls, the delayed shutdown of the LEDs tends to leave ghost shadows around the animated patterns on the billboard and make the animations or text scrolls unrecognizable.

Hence, the present invention is herein proposed with the attempt to solve the existing problem related to delayed LED shutdown caused by the prolonged falling time t2 of a PWM signal.

### SUMMARY OF THE INVENTION

To remedy the aforementioned problem, one object of the present invention is to provide a driving circuit for instant LED shutdown. The driving circuit uses a shunt to shunt a current in an LED driving circuit so that upon turning off an LED, the majority of a residual current is led to the shunt, thereby expediting complete shutdown of the LED.

For achieving this object, the driving circuit for instant LED shutdown comprises:

a light emission driving circuit having a first PWM unit and a power converting unit, wherein the power converting unit generates a driving current signal according to a signal generated by the first PWM unit so that the driving current signal drives the LEDs;

a shunt connected in parallel with the LEDs and configured for shunting a residual driving current of the LEDs after the power converting unit is turned off; and

a second PWM unit for generating a signal which level is opposite to that of the signal generated by the first PWM unit so as to switch on or off an electrical connection between the shunt and the light emission driving circuit,

thereby when the signal generated by the second PWM unit is at a low level, the electrical connection between the shunt and the light emission driving circuit is switched off, and when the signal generated by the second PWM unit is at a high level, the electrical connection between the shunt and the light emission driving circuit is switched on so that a residual current in the light emission driving circuit is partially led to the shunt, so as to achieve instant LED shutdown.

According to driving circuit for instant LED shutdown of the present invention, the resistance is less than the total resistance of the LEDs.

According to driving circuit for instant LED shutdown of the present invention, the second PWM unit is an inverter that generates the signal which level is opposite to the level of the signal generated by the first PWM unit so as to switch on or off the electrical connection between the shunt and the light emission driving circuit.

### BRIEF DESCRIPTION OF THE DRAWINGS

The invention as well as a preferred mode of use, further objects, and advantages thereof will be best understood by reference to the following detailed description of illustrative embodiments when read in conjunction with the accompanying drawings, wherein:

FIG. 1 is a waveform diagram showing an ideal waveform of a PWM signal;

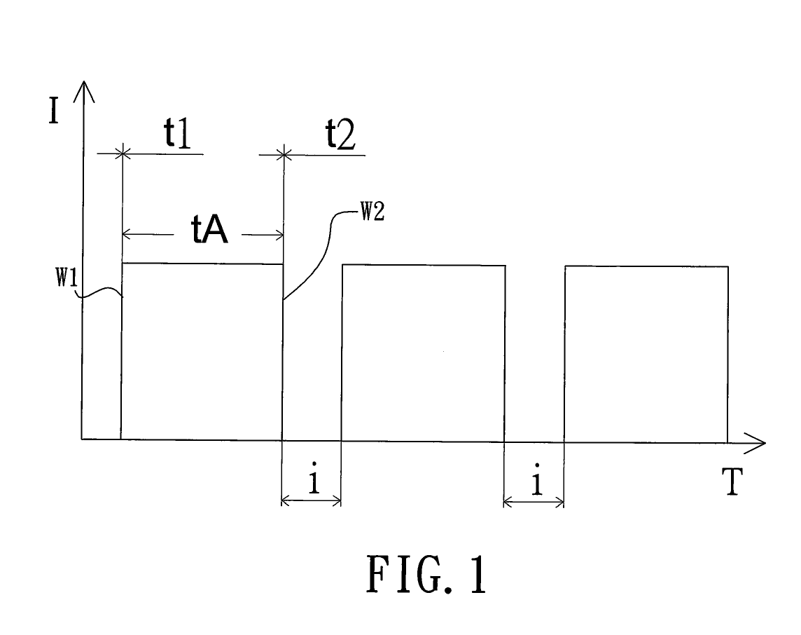

FIG. 2 is a waveform diagram showing a practical waveform of a PWM signal;

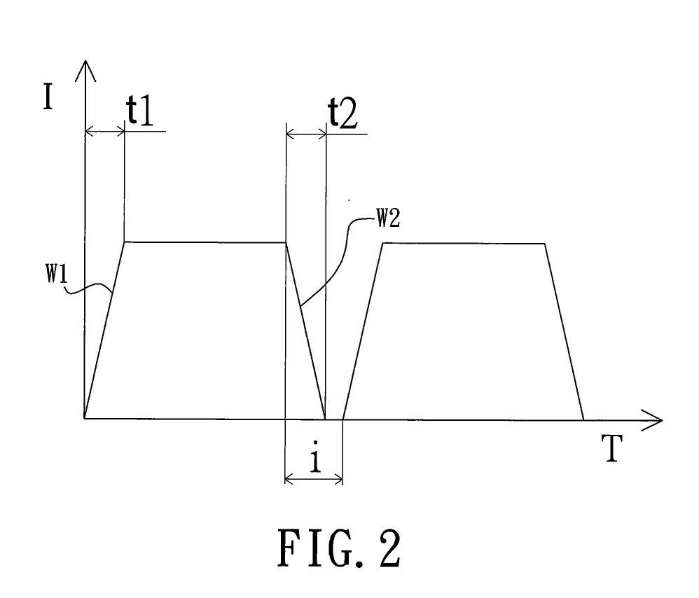

FIG. 3 is a circuit diagram of a driving circuit for instant LED shutdown according to a first embodiment of the present invention;

FIG. 4 is a waveform diagram showing the waveform of a PWM signal generated by the driving circuit of FIG. 3; and

FIG. 5 is a circuit diagram of a driving circuit for instant LED shutdown according to a second embodiment of the present invention, wherein an inverter is used in place of a second PWM unit in the first embodiment.

### DETAILED DESCRIPTION OF THE PREFERRED EMBODIMENT

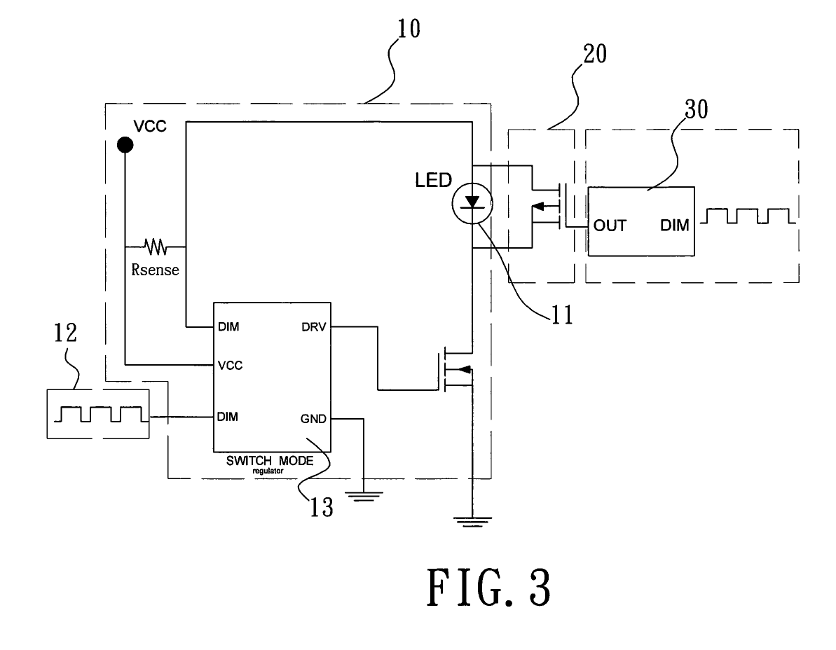

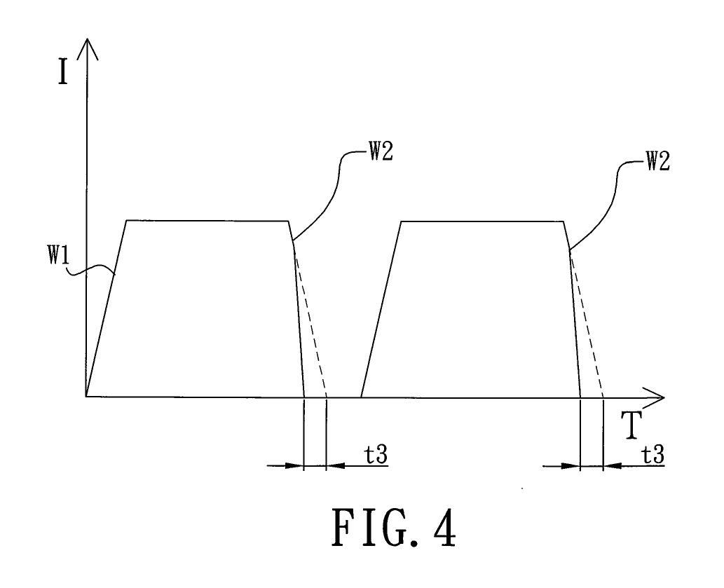

Please refer to FIG. 3 for a circuit diagram of a driving circuit for instant LED shutdown according to a first embodiment of the present invention and to FIG. 4 for a waveform diagram showing the waveform of a PWM signal generated by the driving circuit of FIG. 3.

As shown in FIG. 3, the disclosed driving circuit comprises a light emission driving circuit 10, a shunt 20, and a second PWM unit 30. When the light emission driving circuit 10 turns off LEDs 11, a signal generated by the second PWM unit 30 switches on an electrical connection between the shunt 20 and the light emission driving circuit 10 so that a residual current in the light emission driving circuit 10 is partially led to the shunt 20, thereby achieving instant shutdown of the LEDs 11.

The light emission driving circuit 10 serves to drive the LEDs 11. The number of LEDs in the LEDs 11 and the type of connections between the LEDs are not to be limited in the present invention and may be varied as needed. The light emission driving circuit 10 at least includes a first PWM unit 12 and a power converting unit 13, wherein, the power converting unit 13 serves not only to rectify and regulate an AC power source to predetermined voltage and current values, but also to generate a driving current signal according to a high-level signal generated by the first PWM unit 12, so as to drive the LEDs 11.

The shunt 20 is connected in parallel with the LEDs 11 and serves to shunt part of the residual current in the light emission driving circuit 10 to the shunt 20 upon turning off the LED array 11, thereby shortening the time required for the LEDs 11 to be completely turn off. Whether the electrical connection between the shunt 20 and the light emission driving circuit 10 is switched on or off is controlled mainly by the second PWM unit 30. The signal generated by the second PWM unit 30 is at a level opposite to that of the signal generated by the first PWM unit 12. Moreover, when the signal generated by the second PWM unit 30 is at a low level, the electrical connection between the shunt 20 and the light emission driving circuit 10 is switched off, so that the driving current signal generated by the light emission driving circuit 10 drives the LEDs 11. When the signal generated by the second PWM unit 30 is at a high level, the electrical connection between the shunt 20 and the light emission driving circuit 10 is switched on, so that the current of the light emission driving circuit 10 is led to the shunt 20, thereby speeding up shutdown of the LED array 11.

Referring to FIG. 3 again, the electrical connection between the light emission driving circuit 10 and the shunt 20 is switched on mainly to divert the majority of the residual current from the LED array 11. According to the equation (I=V/R) provided by Ohm's law, the smaller the resistance R is, the greater the resultant current I will be. Furthermore, the greater current leads to the greater power consumption. Thus, the resistance r of the shunt 20 is less than the total resistance of the LEDs 11. For example, when the resistance of the shunt 20 is 0.03Ω, and the total resistance of the LEDs 11 is 0.07Ω (according to the general resistance of normal LED products), the power required by the shunt 20 is W₂₀=(V²/0.03) while the power required by the LEDs 11 is W₁₁=(V²/0.07). At this time, due to the equal voltage V in the parallel circuit, the shunt 20, which consumes the greater power, will consume the majority of the residual current in the light emission driving circuit 10 and thus speed up current exhaustion at the LEDs 11.

Therefore, the driving circuit for instant LED shutdown according to the present embodiment generates a PWM signal which waveform is shown in FIG. 4. Therein, the falling time t3 of the PWM signal is significantly reduced, and the slope of the trailing edge W2 of the PWM signal is steepened, thereby achieving instant LED shutdown.

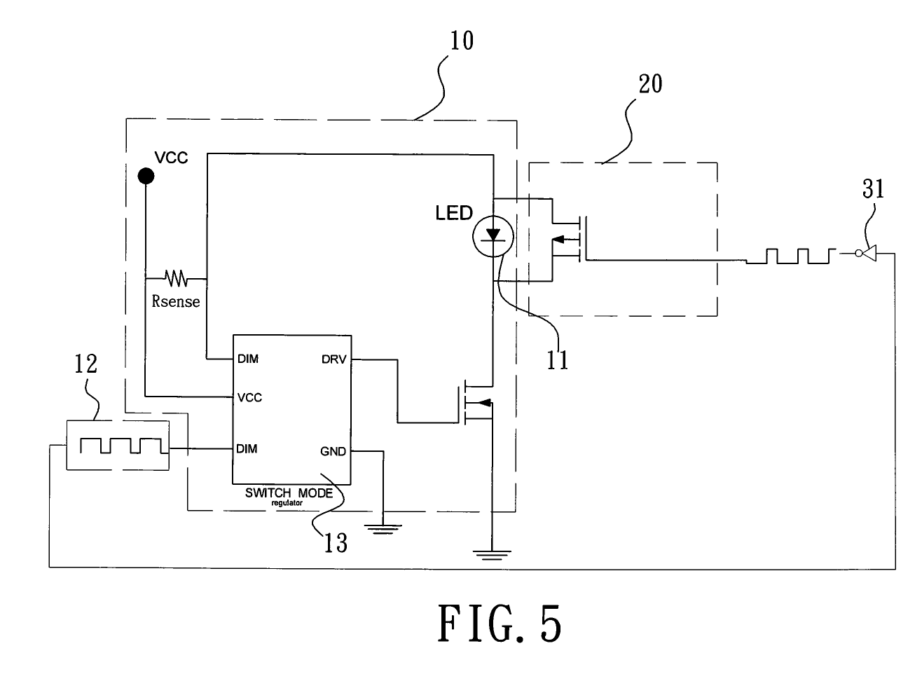

Please refer to FIG. 5 for another embodiment of the driving circuit for instant LED shutdown of the present invention. Therein, the driving circuit is similar to the driving circuit of FIG. 3 except that the second PWM unit 30 of FIG. 3 is herein replaced by an inverter 31. For the sake of simplicity, all the similar components in FIGS. 3 and 5 are indicated by the same numerals and are not described repeatedly herein.

As can be seen in FIG. 5, the present embodiment uses the inverter 31 to replace the second PWM unit 30 of FIG. 3. The inverter 31 serves to generate a signal which level is opposite to that of the signal generated by the first PWM unit 12, so as to switch on or off the electrical connection between the shunt 20 and the light emission driving circuit 10. When the first PWM unit 12 generates a high-level signal, the power converting unit 13 synchronously generates a driving current signal according to the high-level signal generated by first PWM unit 12, thereby light up the LEDs 11. At this time, the inverter 31 generates a low-level signal accordingly so that the electrical connection between the shunt 20 and the light emission driving circuit 10 is switched off. When the signal generated by the first PWM unit 12 is turned to a low level, the driving current signal from the power converting unit 13 is turned into 0, and the signal from the inverter 31 is synchronously turned to a high level. Consequently, the electrical connection between the shunt 20 and the light emission driving circuit 10 is switched on so that the majority of the residual current in the light emission driving circuit 10 is led to the shunt 20, thereby causing the LEDs 11 to go out instantly.

By using the driving circuit for instant LED shutdown of the present invention, not only can LEDs be promptly shut down, but also the blinking frequency of the LEDs can be effectively enhanced, thus improving the problem related to ghost shadows caused by delayed LED shutdown.

Although the invention is described herein in detail by reference to the preferred embodiments, these embodiments are for illustrative purposes only. It will be understood by one of ordinary skill in the art that numerous variations will be possible to the disclosed embodiments without going outside the scope of the invention as defined by the appended claims.

1. A driving circuit for instant LED shutdown, the driving circuit comprising:
a light emission driving circuit having a first PWM unit and a power converting unit, the power converting unit generating a driving current signal according to a signal generated by the first PWM unit, so as to drive the LEDs;
a shunt connected in parallel with the LEDs; and
a second PWM unit for generating a signal which level is opposite to that of the signal generated by the first PWM unit, so as to switch on or off an electrical connection between the shunt and the light emission driving circuit;
thereby when the signal generated by the second PWM unit is at a high level, the electrical connection between the shunt and the light emission driving circuit is switched on, so that a majority of a residual current in the light emission driving circuit is led to the shunt, so as to achieve instant LED shutdown.

2. The driving circuit for instant LED shutdown of claim 1, wherein the resistance of the shunt is less than the total resistance of the LEDs.

3. The driving circuit for instant LED shutdown of claim 1, wherein the second PWM unit is an inverter.
